(19) United States
(12) Patent Application Publication
(10) Pub. No.: US 2008/0118215 A1
(43) Pub. Date: May 22, 2008

(54) Light tunnel structure and manufacturing method thereof

(75) Inventors: Yu-Chuan Chen, Taoyuan Hsien (TW); Sean Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/976,420

(22) Filed: Oct. 24, 2007

(30) Foreign Application Priority Data
Nov. 17, 2006 (TW) 095142579

(51) Int. Cl. G02B 6/00; B29C 65/54

(52) U.S. Cl. 385/133; 156/285; 156/304.1

(57) ABSTRACT

A light tunnel structure includes a plurality of plates and an adhesive (a bonding glue). The plates are connected to each other to form a light tunnel with at least one gap formed at each of the junctions. The adhesive (bonding glue) is filled within the gaps at the junctions. In addition, a manufacturing method of the light tunnel structure is disclosed.

### CROSS REFERENCE TO RELATED APPLICATIONS

This Non-provisional application claims priority under 35 U.S.C. §119(a) on Patent Application No(s). 095142579 filed in Taiwan, Republic of China on Nov. 17, 2006, the entire contents of which are hereby incorporated by reference.

### BACKGROUND OF THE INVENTION

1. Field of Invention

The invention relates to a light tunnel structure and the manufacturing method thereof. In particular, the invention relates to a light tunnel structure with high precision and the manufacturing method thereof.

2. Related Art

The light tunnel is an optical device used in an optical engine of an optical projection system. Its action is to project the light passing through the light tunnel uniformly and precisely in an effective area of a light source modulating device. It prevents the problem of inhomogeneous brightness along a specific optical path of the system. Since the optical projection system requires a high quality demand, it has to be very bright. Therefore, the need of power of the light source is getting higher. This results in high temperatures on the light source. The structure strength and heat resistance therefore become key factors in designing the light tunnels.

Please refer to FIGS. 1A and 1B. A conventional light tunnel structure 1 consists of four long stripes of mirrors, including a top plate 11, a bottom plate 12, a right side plate 13, and a left side plate 14. These long stripes of mirrors 11 to 14 enclose a hollow structure. Their inner walls are coated with optical films with high reflectivity. The light tunnel structure 1 is formed by pressing the top plate 11 and the bottom plate 12 against the right side plate 13 and the left side plate 14. A photoset adhesive (bonding glue) 15, such as the UV glue or the mixture of UV glue and epoxy resin (hereinafter as UV-Epoxy glue), is used to temporarily fix and position the long stripes of mirrors 11 to 14. Afterwards, a thermoset adhesive (glue) 16, such as the ceramic glue, is used to permanently fix and position them, forming the desired light tunnel structure 1. However, the ceramic glue and the long stripes of mirrors 11 to 14 have similar coefficients of thermal expansion. The coefficient of thermal expansion of the UV glue is larger than those of the ceramic glue and the long stripes of mirrors 11 to 14. Therefore, there is a limit in heat resistance. If the temperature is too high or the system is under a long-term thermal cycle, the UV glue or UV-Epoxy glue will break. This results in a lower bonding strength and even renders the combination of these long stripes of mirrors 11 to 14 and the UV glue or UV-Epoxy glue ineffective.

Please refer to FIGS. 2A and 2B. Another conventional light tunnel structure 2 also has four long stripes of mirrors, including a top plate 21, a bottom plate 22, a right side plate 23, and a left side plate 24. The combination of the mirrors 21 to 24 is featured in that: the top plate 21 and the bottom plate 22 have ladder-like grooves so that the right side plate 23 and the left side plate 24 can be embedded into the top plate 21 and the bottom plate 22. Such a combination ensures a stronger strength of combination in the light tunnel structure 2. The precisions in the internal sizes of the light tunnel structure 2 and the four internal angles are determined by the precisions of the ladder-like grooves on the top plate 21 and the bottom plate 22. Therefore, the overall precision of the light tunnel structure 2 is difficult to control, resulting in a higher production cost and sale price.

It is therefore imperative to provide a light tunnel structure and the manufacturing method thereof to simultaneously improve the precision requirement and simplify the manufacturing process, so that the adhesive (glue) does not break and weaken the bonding strength. It is hoped to increase the yield and reliability of the product and to decrease the cost of manufacturing.

### SUMMARY OF THE INVENTION

In view of the foregoing, the invention is to provide a light tunnel structure and the manufacturing method thereof. By forming gaps at the combining interfaces between two adjacent plates and filling the gaps with an adhesive (a bonding glue), the precision requirement in angles can be achieved. This helps increasing the yield and lowering the cost.

In view of the foregoing, the invention is also to provide a manufacturing method of a light tunnel structure. Using the property that the thermoset glue and the plates that form the light tunnel have similar coefficients of thermal expansion, the invention prevents the breakdown of the glue using only the thermoset glue and does not contain the photoset adhesive (bonding glue).

To achieve the above, the invention discloses a light tunnel structure including a plurality of plates and an adhesive (a bonding glue) such as the thermoset glue. The plates are connected to each other to form a light tunnel with at least one gap formed at each of the junctions of the plates. The adhesive (bonding glue) fills the gaps at the junctions.

To achieve the above, the invention also discloses a manufacturing method of a light tunnel structure including the following steps. First, a tool and a plurality of plates are provided. The plates are attached tightly against the tool and connected to form a light tunnel with at least one gap formed at each of junctions of the plates. Then, an adhesive (a bonding glue) fills into the gaps at the junctions. Finally, the tool is removed.

As mentioned above, in the light tunnel structure and manufacturing method thereof of the invention, gaps are formed at the junctions of adjacent plates to increase the precision in the perpendicularity of the light tunnel structure as well as the junction area. Moreover, the invention only uses a thermoset glue to fill the gap. This method avoids using different adhesives (bonding glues), so that the light tunnel structure is not broken due to different coefficients of thermal expansion of the different adhesives (bonding glues). In comparison with the prior art, the gaps of the invention allow adjustments in the precision of perpendicularity. This improves the drawback of errors in the sizes of light tunnel components. Therefore, the yield and reliability of the products can be increased. In addition, the production cost can be lowered.

### BRIEF DESCRIPTION OF THE DRAWINGS

The invention will become more fully understood from the detailed description given herein below illustration only, and thus is not limitative of the present invention, and wherein:

FIG. 1A is a schematic illustration of a conventional light tunnel structure;

FIG. 1B is a cross-sectional view of the light tunnel structure in FIG. 1A;

FIG. 2A is a schematic illustration of another conventional light tunnel structure;

FIG. 2B is a cross-sectional view of the light tunnel structure in FIG. 2A;

FIG. 3A is a schematic illustration of a light tunnel structure according to an embodiment of the invention;

FIG. 3B is a cross-sectional view of the light-tunnel structure in FIG. 3A; and

FIGS. 4A to 4C are schematic illustrations showing the steps of the manufacturing method of a light tunnel structure according to the embodiment of the invention.

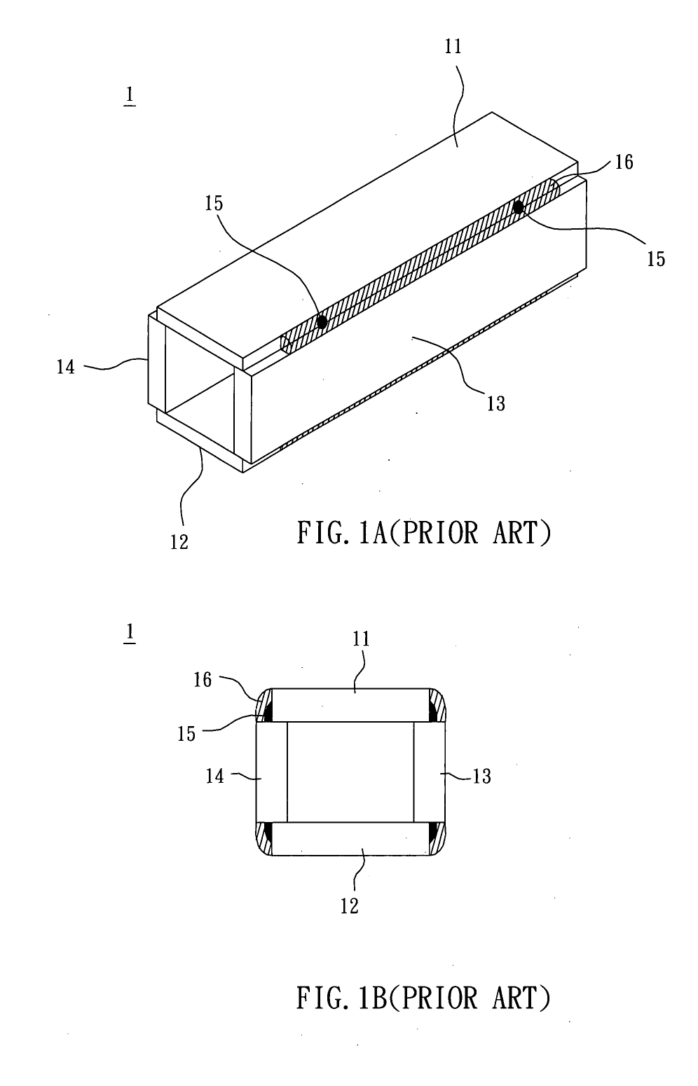

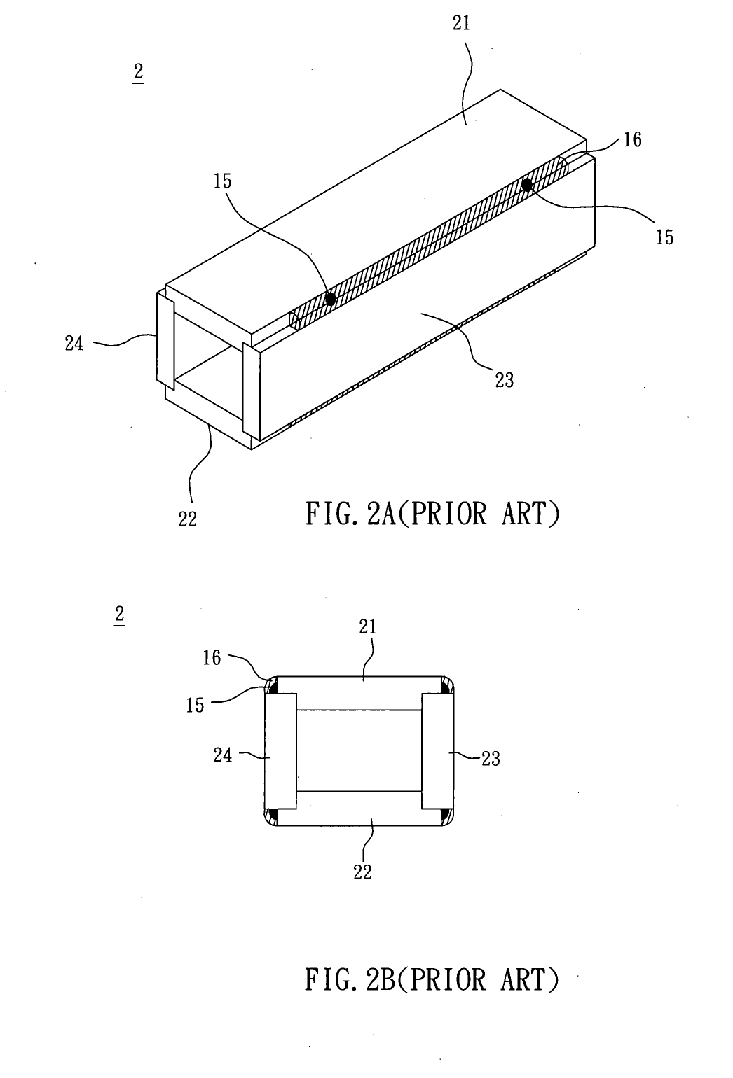

### DETAILED DESCRIPTION OF THE INVENTION

The present invention will be apparent from the following detailed description, which proceeds with reference to the accompanying drawings, wherein the same references relate to the same elements.

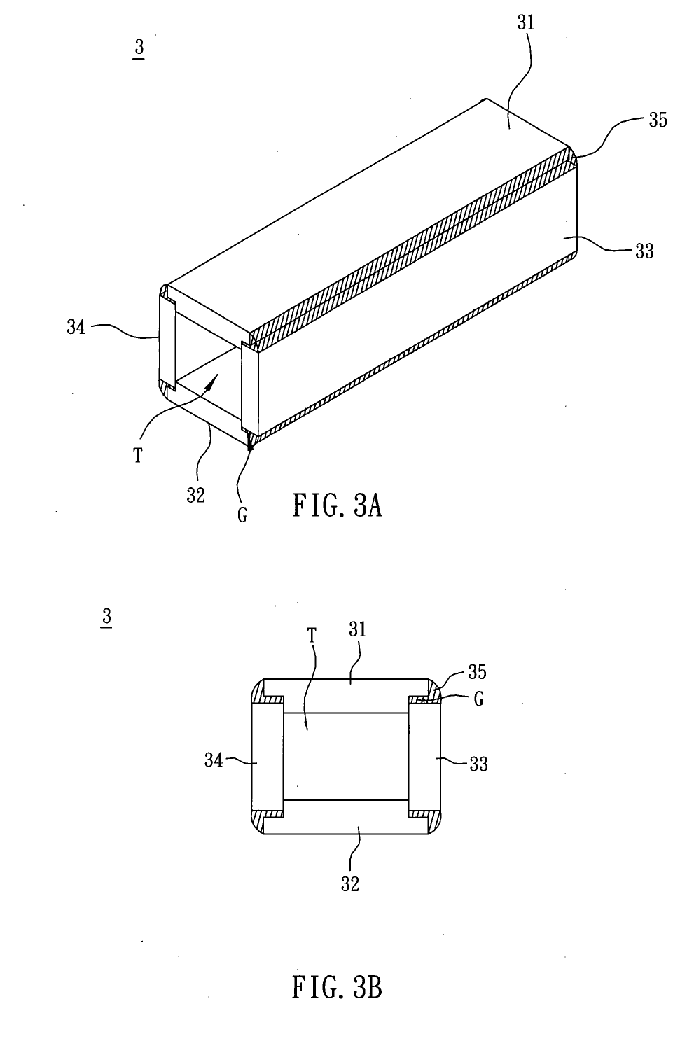

Please refer simultaneously to FIGS. 3A and 3B. A light tunnel structure 3 according to an embodiment of the invention is used in a light integration rod or light guide tube of a projection system. The light tunnel structure 3 includes a top plate 31, a bottom plate 32, a right side plate 33, a left side plate 34 and an adhesive (a bonding glue) 35. The top plate 31 and the bottom plate 32 have two perpendicular notches at the combining interfaces. The right side plate 33 and left side plate 34 press against the perpendicular notches of the top plate 31 and the bottom plate 32, forming a light tunnel T. Each of the plates 31 to 34 is formed with a reflective layer (not shown) on the side of the light tunnel T. The material can be a metal, alloy or dielectric, but not limited to these examples. It should be noted that the junction between the plates 31 to 34 has at least a gap G for filling an adhesive (a bonding glue) 35. The adhesive (bonding glue) 35 is a thermoset glue, such as the silicon glue, ceramic glue, inorganic glue and other equivalent bonding glues.

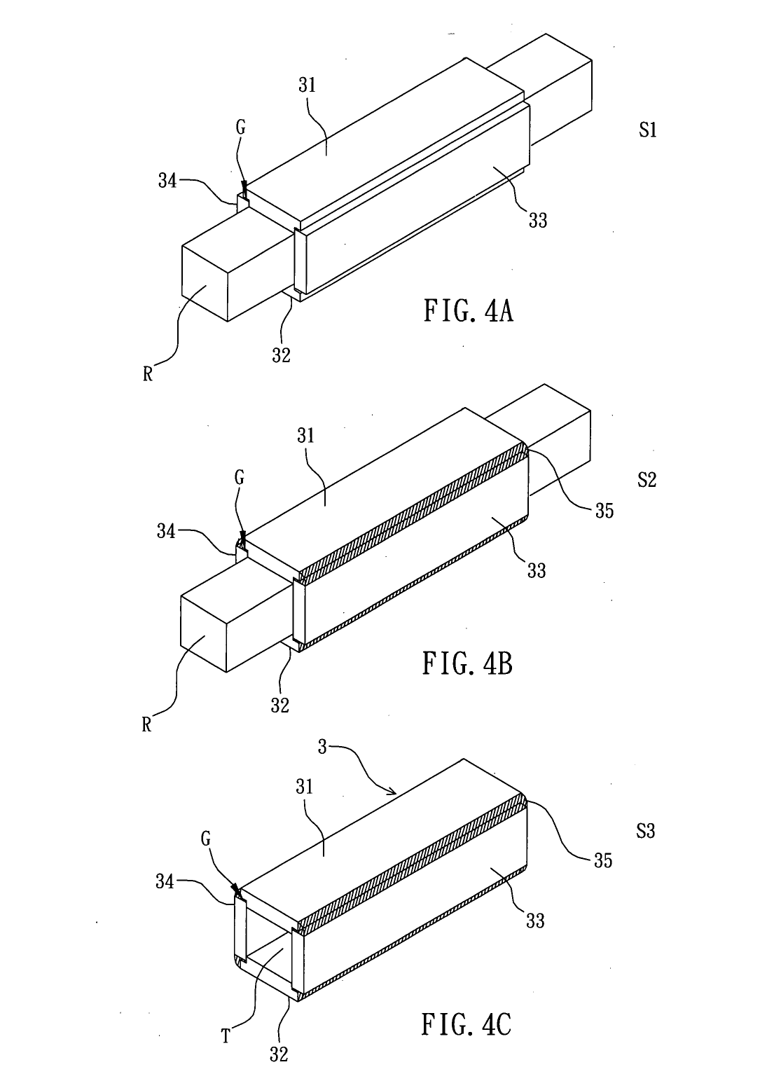

Please refer to FIGS. 4A to 4C. The manufacturing method of the light tunnel structure 3 includes the following steps. First, a rectangular stripe tool R is provided to define the light tunnel T. The plates 31 to 34 are tightly attached against the tool R by pressing or vacuum sucking. They are combined to form a light tunnel T. Each junction of the two adjacent plates has at least one gap G, as shown in FIG. 4A. Afterwards, an adhesive (a bonding glue) 35 is filled in the gaps G at the junctions of the plates 31 to 34, as shown in FIG. 4B. The adhesive (bonding glue) 35 is a thermoset glue, such as the silicon glue, ceramic glue, inorganic glue or other equivalent glue. The precision in the perpendicularity of the plates 31 to 34 can be adjusted by the gaps G. Moreover, the bonding area of the adhesive (bonding glue) 35 is increased to enhance the bonding strength. The adhesive (bonding glue) 35 is thermally cured. Finally, the tool R is removed. This finishes the manufacturing of the light tunnel structure 3, and the result is shown in FIG. 4C.

In summary, in the light tunnel structure and manufacturing method thereof of the invention, gaps are formed at the junctions of adjacent plates to increase the precision in the perpendicularity of the light tunnel structure as well as the junction area. Moreover, the invention only uses a thermoset glue to fill the gap. This method avoids using different adhesive (bonding glues), so that the light tunnel structure is not broken due to different coefficients of thermal expansion of the different (bonding) glues. In comparison with the prior art, the gaps of the invention allow adjustments in the precision of perpendicularity. This improves the drawback of errors in the sizes of light tunnel components. Therefore, the yield and reliability of the products can be increased. In addition, the production cost can be lowered. Furthermore, the invention does not require the use of a photoset glue for temporary positioning and a thermoset glue for permanent fixing and positioning. Thus, the assembly process involves fewer and simpler steps.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light tunnel structure comprising:
a plurality of plates connected to each other to form a light tunnel with at least one gap formed at each junction of the plates; and
an adhesive filling in the gaps.

2. The light tunnel structure of claim 1, wherein the adhesive is a thermoset glue.

3. The light tunnel structure of claim 1, wherein the adhesive is selected from the group consisting of silicon glues, ceramic glues, inorganic glues and any equivalent.

4. The light tunnel structure of claim 1, wherein each of the plates is formed with a reflective layer.

5. The light tunnel structure of claim 4, wherein the material of the reflective layer is a metal, alloy or dielectric.

6. The light tunnel structure of claim 1, wherein the light tunnel structure is a light integration rod or a light guide tube.

7. The light tunnel structure of claim 1, wherein the light tunnel structure is applied to a projection system.

8. A manufacturing method of a light tunnel structure comprising steps of:
providing a tool;
providing a plurality of plates, wherein the plates are abutted against the tool to form a light tunnel with at least one gap formed at each junction of the plates;
filling an adhesive into the gaps; and
removing the tool.

9. The method of claim 8, wherein the tool is rectangular or a long stripe.

10. The method of claim 8, wherein the plates are abutted against the tool by pressing or vacuum sucking.

11. The method of claim 8 further comprising a step of:
curing the adhesive after the step of filling the adhesive.

12. The method of claim 11, wherein the adhesive is cured thermally.

13. The method of claim 8, wherein the bonding glue is selected from the group consisting of silicon glues, ceramic glues, inorganic glues and any equivalent.

14. The method of claim 8, wherein each of the plates is formed with a reflective layer.

15. The method of claim 14, wherein the material of the reflective layer is a metal, alloy or dielectric.

16. The method of claim 8, wherein the light tunnel structure is a light integration rod or a light guide tube.

17. The method of claim 8, wherein the light tunnel structure is applied to a projection system.
